(19) United States
(12) Patent Application Publication
(10) Pub. No.: US 2022/0002056 A1
(43) Pub. Date: Jan. 6, 2022

(54) PACKAGING BAG AND METHOD OF MAKING AND USING THE SAME

(71) Applicant: SAINT-GOBAIN PERFORMANCE PLASTICS CORPORATION, Solon, OH (US)

(72) Inventors: Avery A. HALLETT, Syracuse, NY (US); Joshua MARTELL, Midland, MI (US)

(21) Appl. No.: 17/365,289

(22) Filed: Jul. 1, 2021

Related U.S. Application Data
(60) Provisional application No. 63/047,129, filed on Jul. 1, 2020.

(51) Int. Cl. B65D 75/58; B65B 55/08; B65D 30/08

(52) U.S. Cl. CPC B65D 75/5805; A61J 1/00; B65D 31/02; B65B 55/08

(57) ABSTRACT

The present application is directed to a packaging bag including a transparent body having a first film composition; and a tearable or peelable header comprising a second film composition, wherein the first film composition and the second film composition are different, wherein a component of the first film composition is bonded to the second film composition.

### CROSS-REFERENCE TO RELATED APPLICATION(S)

This application claims priority under 35 U.S.C. § 119(e) to U.S. Provisional Application No. 63/047,129, entitled “PACKAGING BAG AND METHOD OF MAKING AND USING THE SAME,” by Avery A. HALLETT et al., filed Jul. 1, 2020, which is assigned to the current assignee hereof and incorporated herein by reference in its entirety.

### FIELD OF THE DISCLOSURE

The present disclosure relates to a packaging bag, and more particularly to, a packaging bag with a transparent body and a tearable or peelable header.

### RELATED ART

Packaging bags are used for packaging many products shipped and sold. In some cases, packaging bags may be used to ship sensitive products that are used in clean room or sterilized conditions, such as medical, biological, or pharmaceutical products. In some cases, these packaging bags must be sterilized themselves to avoid contamination of the packaging bag surroundings when and where the product is needed. In certain cases, vaporized hydrogen peroxide (VHP) sterilization is required such that VHP resistant packaging is needed to protect these sensitive products. However, these VHP packaging bags may not be transparent and may be difficult to open without the use of tools (including sharps). This may prove burdensome in sterilized conditions. Therefore, improvements in packaging bags are needed, particularly in enabling packaging bags to achieve optimal VHP resistance while allowing improved ease of use.

### BRIEF DESCRIPTION OF THE DRAWINGS

Embodiments are illustrated by way of example and are not limited in the accompanying figures.

FIG. 1 illustrates a top view of a first face of a packaging bag according to a number of embodiments of the present disclosure.

FIG. 2 illustrates a top view of a second face of a packaging bag according to a number of embodiments of the present disclosure.

FIG. 3A illustrates a perspective view of a packaging bag according to a number of embodiments of the present disclosure.

FIG. 3B illustrates a cross-section view of the packaging bag of FIG. 3A through section line 3, in a first configuration according to a number of embodiments of the present disclosure.

FIG. 3C illustrates a cross-section view of the packaging bag of FIG. 3A through section line 3, in a second configuration according to a number of embodiments of the present disclosure.

FIG. 4 illustrates a side view of the first film composition of the transparent body of the packaging bag according to a number of embodiments of the present disclosure.

FIG. 5 illustrates a side view of the second film composition of the header of the packaging bag according to a number of embodiments of the present disclosure.

Skilled artisans appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

### DETAILED DESCRIPTION

The following description in combination with the figures is provided to assist in understanding the teachings disclosed herein. The following discussion will focus on specific implementations and embodiments of the teachings. This focus is provided to assist in describing the teachings and should not be interpreted as a limitation on the scope or applicability of the teachings. However, other embodiments can be used based on the teachings as disclosed in this application.

The terms “comprises,” “comprising,” “includes,” “including,” “has,” “having” or any other variation thereof, are intended to cover a non-exclusive inclusion. For example, a method, article, or apparatus that comprises a list of features is not necessarily limited only to those features but may include other features not expressly listed or inherent to such method, article, or apparatus. Further, unless expressly stated to the contrary, “or” refers to an inclusive-or and not to an exclusive-or. For example, a condition A or B is satisfied by any one of the following: A is true (or present) and B is false (or not present), A is false (or not present) and B is true (or present), and both A and B are true (or present).

Also, the use of “a” or “an” is employed to describe elements and components described herein. This is done merely for convenience and to give a general sense of the scope of the invention. This description should be read to include one, at least one, or the singular as also including the plural, or vice versa, unless it is clear that it is meant otherwise. For example, when a single embodiment is described herein, more than one embodiment may be used in place of a single embodiment. Similarly, where more than one embodiment is described herein, a single embodiment may be substituted for that more than one embodiment.

Unless otherwise defined, all technical and scientific terms used herein have the same meaning as commonly understood by one of ordinary skill in the art to which this invention belongs. The materials, methods, and examples are illustrative only and not intended to be limiting. To the extent not described herein, many details regarding specific materials and processing acts are conventional and may be found in textbooks and other sources within the packaging bag arts.

The following disclosure describes packaging bags adapted to achieve substantial seal engagement to the container to ensure an adequate seal in assembling a packaging bag and container. The concepts are better understood in view of the embodiments described below that illustrate and do not limit the scope of the present invention.

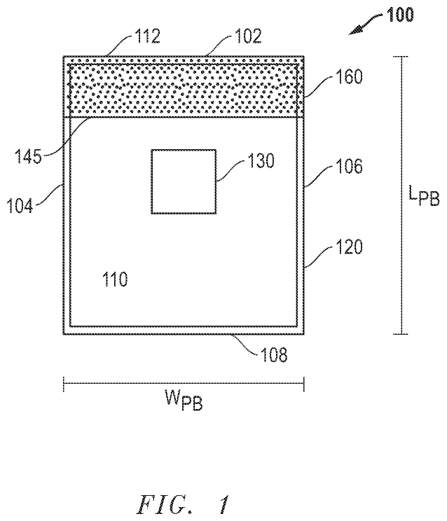

For purposes of illustration, FIG. 1 illustrates a top view of a first face of a packaging bag according to a number of embodiments of the present disclosure. As best illustrated in FIG. 1, the packaging bag 100 may include a top edge 102, a left edge 104, a right edge 106, and a base edge 108. The packaging bag 100 may include a first face (or front side) 110 and a second face (or back side) 112 opposite the first face 100. As shown in FIG. 1, the packaging bag 100 may include a transparent body 120 having a first film composition. The packaging bag 100 may further include a tearable or peelable header 160 having a second film composition. In the first face 110, the transparent body 120 may meet the header 160 at a first interface 145. In a number of embodiments, the first face 110 of the packaging bag 100 may be generally polygonal cross-section (e.g. rectangular). In a number of variations, the first face 110 of the packaging bag 100 may have a polygonal, oval, circular, semi-circular, or substantially circular cross-section. In a number of embodiments, the first face 110 of the packaging bag 100 may be generally flat.

In a number of embodiments, the packaging bag 100 may have a width W_{PB}. For purposes of embodiments described herein and as shown in FIG. 1, the width W_{PB} of the packaging bag 100 is the distance from the left edge 104 to the right edge 106. According to certain embodiment, the width W_{PB} of the packaging bag 100 may be at least about 100 mm, such as, at least about 150 mm or at least about 200 mm or at least about 250 mm or at least about 300 mm or even at least about 500 mm. According to still other embodiments, the width W_{PB} of the packaging bag 100 may be not greater than about 1500 mm, such as, not greater than about 1200 mm or even not greater than about 1000 mm. It will be appreciated that the width W_{PB} of the packaging bag 100 may be within a range between any of the minimum and maximum values noted above. It will be further appreciated that the width W_{PB} of the packaging bag 100 may be any value between any of the minimum and maximum values noted above.

In a number of embodiments, the packaging bag 100 can have a length L_{PB}. For purposes of embodiments described herein and as shown in FIG. 1, the length L_{PB} of the packaging bag 100 is the distance from the top edge 102 to the base edge 108. According to certain embodiment, the length L_{PB} of the packaging bag 100 may be at least about 100 mm, such as, at least about 150 mm or at least about 200 mm or at least about 250 mm or at least about 300 mm, or even at least about 500 mm. According to still other embodiments, the length L_{PB} of the packaging bag 100 may be not greater than about 1500 mm, such as, not greater than about 1200 mm or even not greater than about 1000 mm. It will be appreciated that the length L_{PB} of the packaging bag 100 may be within a range between any of the minimum and maximum values noted above. It will be further appreciated that the length L_{PB} of the packaging bag 100 may be any value between any of the minimum and maximum values noted above.

In some embodiments, the packaging system 100 is configured to contain a product 130. The product may be medical, biological, or pharmaceutical device, such as a vascular catheter. In specific embodiments, the packaging system may contain a product type for biopharma/life sciences that are designed for a single use.

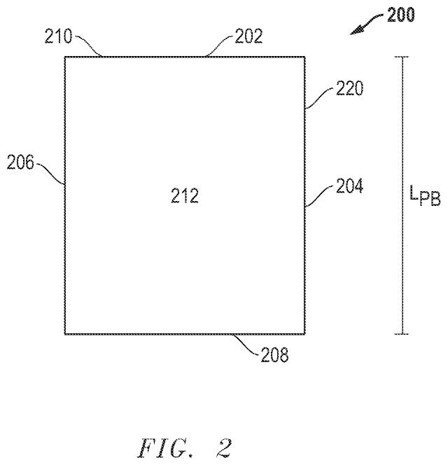

For purposes of illustration, FIG. 2 illustrates a top view of a second face of a packaging bag according to a number of embodiments of the present disclosure. As best illustrated in FIG. 1, the packaging bag 200 may include a top edge 202, a left edge 204, a right edge 206, and a base edge 208. The packaging bag 200 may include a first face (or front side) 210 and a second face (or back side) 212 opposite the first face 200. In an embodiment, the transparent body 220 may make up the entirety of the length, L_{PB}, of the packaging bag 200 along the second face (or back side) 212. In an embodiment, the header 160 may make up the entirety of the length, L_{PB}, of the packaging bag 200 along the second face (or back side) 212. In other words, at least one of the front side or back side may include one of the body (first film composition) or the header (second film composition).

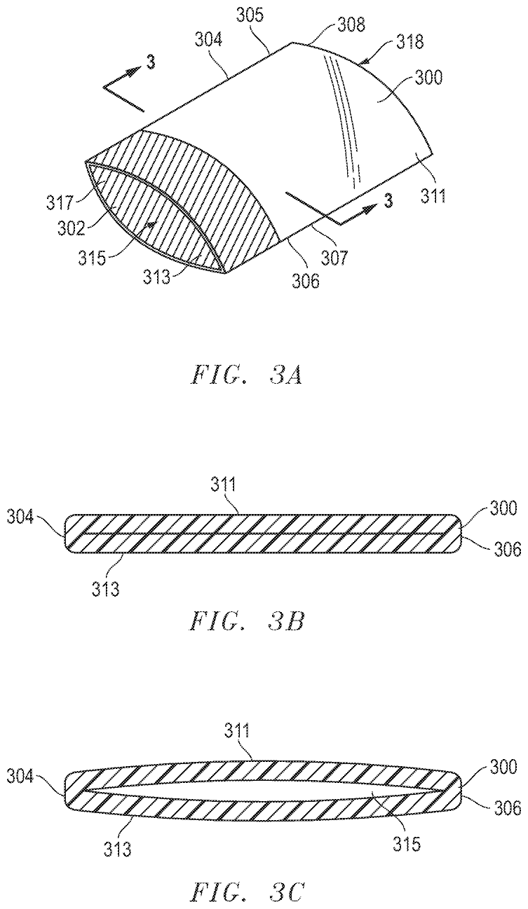

For purposes of illustration, FIG. 3A illustrates a perspective view of a packaging bag according to a number of embodiments of the present disclosure. FIG. 3B illustrates a cross-section view of the packaging bag of FIG. 3A through section line 3, in a first configuration according to a number of embodiments of the present disclosure. FIG. 3C illustrates a cross-section view of the packaging bag of FIG. 3A through section line 3, in a second configuration according to a number of embodiments of the present disclosure. Referring to FIGS. 3A-3C, the packaging bag 300 is configured as a bag or sleeve having a top edge 302, a left edge 304, a right edge 306, and a base edge 308. The bag may have a first wall 311 (opposite the first face), a second wall 313 (opposite the first face), an open end 317, a closed end 318, and closed lateral sides 305, 307 such that an internal cavity 315 is created. In some embodiments, the packaging bag 300 may be configured as a tube including at least one open end. In other embodiments, the packaging bag 300 may be opened at a proximal and/or a distal end. In still other embodiments, the packaging bag 300 may be opened along a portion of one of the first wall 311 or second wall 313.

In particular embodiments, at least one of the packaging bag, the first film composition, or the second film composition can be formed of a material including a polymer. In an embodiment, at least one of the packaging bag, the first film composition, or the second film composition may include a blend of polymers or polymeric polymers including a thermoplastic elastomeric hydrocarbon block copolymer, a polyether-ester block co-polymer, a thermoplastic polyamide elastomer, a thermoplastic polyurethane elastomer, a thermoplastic polyolefin elastomer, a thermoplastic vulcanizate, an olefin-based co-polymer, an olefin-based ter-polymer, a polyolefin plastomer, or combinations thereof. In an embodiment, at least one of the packaging bag, the first film composition, or the second film composition may include a styrene based block copolymer such as styrene-butadiene, styrene-isoprene, blends or mixtures thereof, mixtures thereof, and the like. Exemplary styrenic thermoplastic elastomers include triblock styrenic block copolymers (SBC) such as styrene-butadiene-styrene (SBS), styrene-isoprene-styrene (SIS), styrene-ethylene butylene-styrene (SEBS), styrene-ethylene propylene-styrene (SEPS), styrene-ethylene-ethylene-butadiene-styrene (SEEBS), styrene-ethylene-ethylene-propylene-styrene (SEEPS), styrene-isoprene-butadiene-styrene (SIBS), or combinations thereof. Commercial examples include some grades of Kraton™ and Hybrar™ resins.

In an embodiment, at least one of the packaging bag, the first film composition, or the second film composition may include a polyolefin polymer. A typical polyolefin may include a homopolymer, a copolymer, a terpolymer, an alloy, or any combination thereof formed from a monomer, such as ethylene, propylene, butene, pentene, methyl pentene, hexene, octene, or any combination thereof. In an embodiment, the polyolefin polymer may be copolymers of ethylene with propylene or alpha-olefins or copolymers of polypropylene with ethylene or alpha-olefins made by metallocene or non-metallocene polymerization processes. Commercial polyolefin examples include Affinity™, Engage™, Flexomer™, Versify™, Infuse™, Exact™, Vistamaxx™, Softel™ and Tafmer™, Notio™ produced by Dow, ExxonMobil, Londel-Basell and Mitsui. In an embodiment, the polyolefin polymer may include copolymers of ethylene with polar vinyl monomers such as acetate (EVA), acrylic acid (EAA), methyl acrylate (EMA), methyl methacrylate (EMMA), ethyl acrylate (EEA) and butyl acrylate (EBA). Exemplary suppliers of these ethylene copolymer resins include DuPont, Dow Chemical, Mitusi and Arkema etc. In another embodiment, the polyolefin polymer can be a terpolymer of ethylene, maleic anhydride and acrylates such as Lotader™ made by Arkema and Evalloy™ produced by DuPont. In yet another embodiment, the polyolefin polymer can be an ionomer of ethylene and acrylic acid or methacrylic acid such as Surlyn™ made by DuPont. In an embodiment, the polyolefin is a reactor grade thermoplastic polyolefin polymer, such as P6E2A-005B available from Flint Hills Resources. In an embodiment, at least one of the packaging bag, the first film composition, or the second film composition may include, but are not limited to, thermoplastic, thermosets, fluropolymers, and combinations thereof. Specific examples of suitable polymer material can be polyvinyldiene fluoride (PVDF). In an embodiment, at least one of the packaging bag, the first film composition, or the second film composition can be formed of a thermoplastic elastomer, silicone, or combinations thereof. For example, specific types of thermoplastic elastomers can be those described in U.S. Patent Application Publication No. 2011/0241262, which is incorporated herein by reference, in its entirety, for all useful purposes.

In an embodiment, at least one of the packaging bag, the first film composition, or the second film composition may include a fluorinated polymer. In an embodiment, at least one of the packaging bag, the first film composition, or the second film composition may include a polymer including at least one of ethylene-tetrafluoroethylene, tetrafluoro-ethylene-perfluoro (methyl vinyl ether), polyvinylidene fluoride, ethylene-chlorotrifluoroethylene, polyimide, polyamidimide, polyphenylene sulfide, polyethersulfone, polyphenylene sulfone, liquid crystal polymers, polyetherketone, polyether ether ketones, aromatic polyesters (Ekonol), of polyether-ether-ketone, polyetherketone, liquid crystal polymer, polyamide, polyethylene/UHMPE, polypropylene, polystyrene, styrene butadiene copolymers, polyesters, polycarbonate, polyacrylonitriles, polyamides, styrenic block copolymers, ethylene vinyl alcohol copolymers, ethylene vinyl acetate copolymers, polyesters grafted with maleic anhydride, poly-vinylidene chloride, aliphatic polyketone, liquid crystalline polymers, ethylene methyl acrylate copolymer, ethylene-norbomene copolymers, polymethylpentene and ethylene acyrilic acid copoloymer, mixtures, copolymers and any combination thereof.

Further, in an embodiment, at least one of the packaging bag, the first film composition, or the second film composition can include one or more additives. For example, the one or more additives can include a plasticizer, a catalyst, a silicone modifier, a silicon component, a stabilizer, a curing agent, a lubricant, a colorant, a filler, a blowing agent, another polymer as a minor component, or a combination thereof. In a particular embodiment, the plasticizer can include mineral oil.

In an embodiment, at least one of the packaging bag, the first film composition, or the second film composition can be formed as a single piece or may be formed as multiple pieces. In an embodiment, at least one of the packaging bag, the first film composition, or the second film composition can be a molded component. In an embodiment, at least one of the packaging bag, the first film composition, or the second film composition can be formed through over-molding or other methods known in the art. In an embodiment, the polymer or polymeric blend included in at least one of the packaging bag, the first film composition, or the second film composition may be processed by any known method to form the polymeric mixture. The polymer or polymeric blend may be melt processed by dry blending or compounding. The dry blend may be in powder, granular, or pellet form. The blend can be made by a continuous twin-screw compounding process or batch related Banbury process. Pellets of these mixtures may then be fed into a single screw extruder to make articles such as flexible tubing products. Mixtures can also be mixed in a single-screw extruder equipped with mixing elements and then extruded directly into articles such as tubing products. In a particular embodiment, the mixture can be melt processed by any method envisioned known in the art such as laminating, casting, molding, extruding, and the like. In an embodiment, the mixture can be injection molded.

In a number of embodiments, the first film composition may be bonded to the second film composition to form the packaging bag. In a number of embodiments, the polyethylene of the first film composition may be bonded to the polyethylene of the second film composition. In a number of embodiments, this may bond the header to the transparent body to form the packaging bag. In a number of embodiments, the header may be peelable or tearable against the transparent body to open the packaging bag. In a number of embodiments, any of the layers on the first film composition or second film composition as described above, can each be disposed in a roll and peeled therefrom to join together under pressure, at elevated temperatures (hot or cold pressed or rolled), by an adhesive, or by any combination thereof. Any of the layers of the first film composition or second film composition, as described above, may be laminated together such that they at least partially overlap one another. Any of the layers on the first film composition or second film composition as described above, may be applied together using coating technique, such as, for example, physical or vapor deposition, spraying, plating, powder coating, or through other chemical or electrochemical techniques. In a particular embodiment, the first film composition or second film composition may be applied by a roll-to-roll coating process, including for example, extrusion coating. The first film composition or second film composition may be heated to a molten or semi-molten state and extruded through a slot die onto an interior or exterior surface of the other of the first film composition or the second film composition to form the packaging bag.

In an embodiment, the polymer or polymeric blend of at least one of the packaging bag, the first film composition, or the second film composition may be formed into a single layer article, a multi-layer article, or can be laminated, coated, or formed on a substrate to form at least one of the packaging bag, the first film composition, or the second film composition. Multi-layer articles may include layers such as reinforcing layers, adhesive layers, barrier layers, chemically resistant layers, metal layers, any combination thereof, and the like. The polymer or polymeric blend can be formed into any useful shape such as film, sheet, tubing, and the like to form at least one of the packaging bag, the first film composition, or the second film composition.

In an embodiment, the polymer or polymeric blend of at least one of the packaging bag, the first film composition, or the second film composition may be formed into a single layer article, a multi-layer article, or can be laminated, coated, or formed on a substrate to form at least one of the packaging bag, the first film composition, or the second film composition. Multi-layer articles may include layers such as reinforcing layers, adhesive layers, barrier layers, chemically resistant layers, metal layers, any combination thereof, and the like. The polymer or polymeric blend can be formed into any useful shape such as film, sheet, tubing, and the like to form at least one of the packaging bag, the first film composition, or the second film composition.

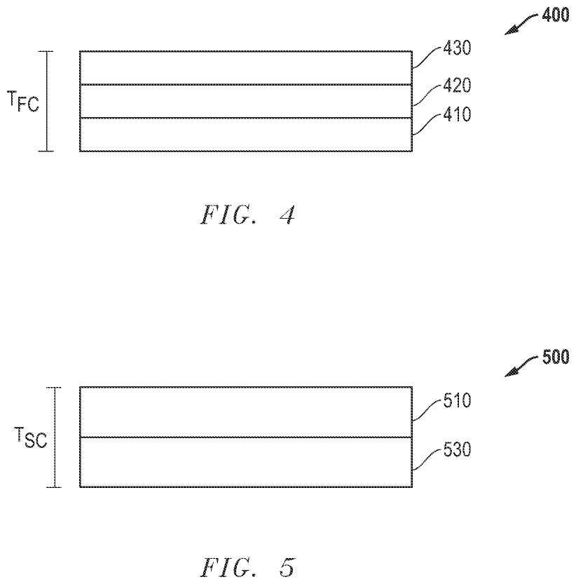

For purposes of illustration, FIG. 4 illustrates a side view of the first film composition of the transparent body of the packaging bag according to a number of embodiments of the present disclosure. In a number of embodiments, the first film composition may be a laminated multi-layer film. In one or a plurality of embodiments, the first film composition 400 includes a base film 410, an intermediate film layer 420 provided on one surface side of the base film or interior layer 410, and the surface film or exterior layer 430. In a number of embodiments, the base film 410 may include nylon. In a number of embodiments, the base film 410 may include polyethylene (high density polyethylene or low density polyethylene). In a number of embodiments, the intermediate film layer 420 may include ethylene vinyl alcohol. In a number of embodiments, the surface film 430 may include nylon. In a number of embodiments, the surface film 430 may include polyethylene (high density polyethylene or low density polyethylene).

In a number of embodiments, the first film composition 400 may have a thickness T_{FC}. For purposes of embodiments described herein and as shown in FIG. 4, the thickness T_{FC} of the first film composition 400 may be at least about 0.001 mm, such as, at least about 0.005, 0.1 mm or at least about 0.2 mm or at least about 0.3 mm or at least about 0.4 mm or even at least about 0.5 mm. According to still other embodiments, the thickness T_{FC} of the first film composition 400 may be not greater than about 1 mm, such as, not greater than about 0.5 mm or even not greater than about 0.25 mm. It will be appreciated that the thickness T_{FC} of the first film composition 400 may be within a range between any of the minimum and maximum values noted above. It will be further appreciated that the thickness T_{FC} of the first film composition 400 may be any value between any of the minimum and maximum values noted above. In a number of embodiments, the thickness T_{FC} of the first film composition 400 may be at least 2 mil and no greater than 15 mil.

For purposes of illustration, FIG. 5 illustrates a side view of the second film composition of the header of the packaging bag according to a number of embodiments of the present disclosure. In a number of embodiments, the second film composition may be a laminated multi-layer film. In one or a plurality of embodiments, the second film composition 500 includes a base film or interior layer 510 and the surface film or exterior layer 530. In a number of embodiments, the base film 510 may include alkyl methacrylate copolymer. In a number of embodiments, the surface film 530 may include polyethylene (high density polyethylene or low density polyethylene). In a number of embodiments, the base film or interior layer 510 and the surface film or exterior layer 530 may include a foil. In a number of embodiments, the foil may include a metal including aluminum, copper, tin, iron, alloys thereof, or may be a different type.

In a number of embodiments, the second film composition 500 may have a thickness T_{SC}. For purposes of embodiments described herein and as shown in FIG. 5, the thickness T_{SC} of the second film composition 500 may be at least about 0.001 mm, such as, at least about 0.005, 0.1 mm or at least about 0.2 mm or at least about 0.3 mm or at least about 0.4 mm or even at least about 0.5 mm. According to still other embodiments, the thickness T_{SC} of the second film composition 500 may be not greater than about 1 mm, such as, not greater than about 0.5 mm or even not greater than about 0.25 mm. It will be appreciated that the thickness T_{SC} of the second film composition 500 may be within a range between any of the minimum and maximum values noted above. It will be further appreciated that the thickness T_{SC} of the second film composition 500 may be any value between any of the minimum and maximum values noted above. In a number of embodiments, the thickness T_{SC} of the second film composition 500 may be at least 2 mil and no greater than 15 mil.

In an embodiment the polymer or polymeric blend of the packaging bag, the first film composition or the second film composition can advantageously withstand sterilization processes. In an embodiment, the polymer or polymeric blend may be sterilized by any method envisioned. For instance, the polymer or polymeric blend is sterilized after at least one of the packaging bag, the first film composition, or the second film composition is formed. Exemplary sterilization methods include X-ray radiation, electron ray, E-beam techniques, combinations thereof, and the like. In a particular embodiment, the polymer or polymeric blend is sterilized by vaporized hydrogen peroxide sterilization (VHP). In a particular embodiment, the polymer or polymeric blend is sterilized by gamma irradiation. For instance, the polymer or polymeric blend of at least one of the packaging bag, the first film composition, or the second film composition may be gamma sterilized at between about 25 kGy to about 50 kGy.

In a number of embodiments, the packaging bag may be vaporized hydrogen peroxide (VHP) resistant. The packaging bag may be VHP resistant at a level of less than 1,000 ppm, such as less than 500 ppm, such as less than 250 ppm, such as less than 100 ppm, such as less than 50 ppm, such as less than 25 ppm, such as less than 10 ppm, such as less than 5 ppm, such as less than 2 ppm, or such as less than 1 ppm.

In embodiment, at least one of the packaging bag, the first film composition, or the second film composition may have further desirable physical and mechanical properties. For instance, at least one of the packaging bag, the first film composition, or the second film composition may appear transparent or at least translucent. For instance, at least one of the packaging bag, the first film composition, or the second film composition may have a light transmission greater than about 2%, or greater than about 5% in the visible light wavelength range. In particular, the resulting articles have desirable clarity or translucency. In addition, at least one of the packaging bag, the first film composition, or the second film composition have advantageous physical properties, such as a balance of any one or more of the properties of hardness, flexibility, surface lubricity, tensile strength, elongation, Shore A hardness, gamma resistance, weld strength, and seal integrity to an optimum level.

In an embodiment, at least one of the packaging bag, the first film composition, or the second film composition may have desirable heat stability properties. Applications for the polymer or polymeric blend are numerous. In particular, the polymer or polymeric blend is non-toxic, making the material useful for any application where no toxicity is desired. For example, the polymer or polymeric blend may be substantially free of plasticizers or other low-molecular weight extenders that can be leached into the fluids it transfers. “Substantially free” as used herein refers to a polymeric mixture having a total organic content (TOC) (measured in accordance to ISO 15705 and EPA 410.4) of less than about 100 ppm. Further, the polymer or polymeric blend has biocompatibility and animal derived component-free formulation ingredients. For instance, the polymeric mixture has potential for FDA, USP, EP, ISO, and other regulatory approvals. In an exemplary embodiment, the polymer or polymeric blend may be used in applications such as industrial, medical, health care, biopharmaceutical, pharmaceutical, drinking water, food & beverage, laboratory, dairy, and the like. In an embodiment, the polymeric mixture may be used in applications where low temperature resistance is desired. In an embodiment, the polymer or polymeric blend may also be safely disposed as it generates substantially no toxic gases when incinerated and leaches no plasticizers into the environment if land filled.

In particular embodiments, packaging bag may be torn or peeled to form an “open position” from a “closed position” In particular embodiments, packaging bag 200 may be tearable or peelable to form an open position upon application of force of no greater than about 10 lbf, no greater than about 5 lbf, no greater than about 2.5 lbf, no greater than about 2 lbf, or no greater than about 1 lbf. The bag may be torn or peeled at the interface between the header and the transparent body, at a location along the header only, or at a location along the transparent body only.

Experiments will be conducted regarding the materials for best peel ability between the header and the transparent body. Materials of the header and the transparent body will be varied through these experiments. A positive performance for the best peel ability between the header and the transparent body may be based on the variations of sizing of the packaging bag and materials of the header and transparent body, some potentially demonstrating criticality. The peel ability between the header and the transparent body may be measured by application of force upon at least one of the header or the transparent body of the packaging bag.

A method may be used for forming a packaging bag according to a number of embodiments. The method may include a first step including providing a transparent body comprising a first film composition. The method may include a second step of providing a tearable or peelable header comprising a second film composition. The method may include a third step of bonding the second film composition to the first film composition to form a closed packaging bag. The method may include a fourth step of sterilizing the packaging bag such that the packaging bag is VHP resistant such that hydrogen peroxide concentration on an interior of the package is less than 1 ppm. Optionally, the method may include a step of disposing a product between the transparent body and the tearable or peelable header before or after bonding the second film composition to the first film composition to form a closed packaging bag.

Use of the packaging bag may provide increased benefits in several applications in fields such as, but not limited to, industrial, medical, health care, biopharmaceutical, pharmaceutical, drinking water, food & beverage, laboratory, dairy, or other types of applications. Notably, the use of the packaging bag or packaging bag and container system may provide a sealing mechanism for housing a product meant for sterilization, such as a medical device, pharmaceutical product, or biological product used in a surgical procedure. Further, the use of the use of packaging bag may provide a VHP resistant container with an ease of transition from a closed position to an open position to remove the product without the use of any tools or sharps. This may provide optimal sealing engagement while allowing improved ease of use in difficult environments, such as operating rooms, hospitals, or pharmacies.

Many different aspects and embodiments are possible. Some of those aspects and embodiments are described below. After reading this specification, skilled artisans will appreciate that those aspects and embodiments are only illustrative and do not limit the scope of the present invention.

Embodiment 1: A packaging bag, comprising: a transparent body having a first film composition; and a tearable or peelable header comprising a second film composition, wherein the first film composition and the second film composition are different, wherein a component of the first film composition is bonded to the second film composition.

Embodiment 2: A packaging assembly comprising: a product; and a packaging bag enclosing the product to provide a sterilize-able packaging assembly, wherein the packing bag comprises: a transparent body having a first film composition; and a tearable or peelable header comprising a second film composition, wherein the first film composition and the second film composition are different, wherein a component of the first film composition is bonded to the second film composition, wherein the packaging bag is VHP resistant such that hydrogen peroxide concentration on an interior of the package is less than 1 ppm.

Embodiment 3: A method for forming a packaging bag, comprising: providing a transparent body comprising a first film composition; providing a tearable or peelable header comprising a second film composition; bonding the second film composition to the first film composition to form a closed packaging bag; and sterilizing the packaging bag such that the packaging bag is VHP resistant such that hydrogen peroxide concentration on an interior of the package is less than 1 ppm.

Embodiment 4: The packaging bag, packaging assembly, or method of any of the preceding embodiments, wherein the first film composition comprises polyethylene.

Embodiment 5: The packaging bag, packaging assembly, or method of any of the preceding embodiments, wherein the second film composition comprises polyethylene.

Embodiment 6: The packaging bag, packaging assembly, or method of embodiment 5, wherein the polyethylene of the first film composition is bonded to the polyethylene of the second film composition.

Embodiment 7: The packaging bag, packaging assembly, or method of any of the preceding embodiments, wherein first film composition comprises a laminated film comprising at least one of nylon or ethylene vinyl alcohol to form a multilayer film.

Embodiment 8: The packaging bag, packaging assembly, or method of any of the preceding embodiments, wherein second film composition comprises a laminated film comprising an alkyl methacrylate copolymer to form a multilayer film.

Embodiment 9: The packaging bag, packaging assembly, or method of embodiment 7, wherein the polyethylene film is an exterior layer or an interior layer of the first film composition.

Embodiment 10: The packaging bag, packaging assembly, or method of embodiment 8, wherein the polyethylene film is an exterior layer or an interior layer of the second film composition.

Embodiment 11: The packaging bag, packaging assembly, or method of any of the preceding embodiments, wherein when the header is peelable against the body.

Embodiment 12: The method of embodiment 3, further comprising disposing a product within the packaging bag before bonding the second film composition to the first film composition.

Embodiment 13: The packaging assembly or method of any of embodiments 2 and 12, wherein the product is a medical or biopharmaceutical device.

Embodiment 14: The method of embodiment 3, wherein the sterilization step is done via radiation sterilization.

Embodiment 15: The method of embodiment 14, wherein the radiation sterilization is done via electron beam sterilization.

Embodiment 16: The packaging bag, packaging assembly, or method of any of the preceding embodiments, wherein the second film composition includes a foil.

Embodiment 17: The packaging bag, packaging assembly, or method of embodiment 16, wherein the foil comprises a metal.

Embodiment 18: The packaging bag, packaging assembly, or method of any of the preceding embodiments, wherein the packaging bag header is tearable or peelable upon application of force of no less than 1 lbf.

Embodiment 19: The packaging bag, packaging assembly, or method of any of the preceding embodiments, wherein the packaging bag comprises a front side and a back side, wherein one of the front side or the back side consists of the first film composition of the body.

Embodiment 20: The packaging bag, packaging assembly, or method of any of the preceding embodiments, wherein the packaging bag comprises a front side and a back side, wherein at least one of the front side or the back side comprises the first film composition of the body and the second film composition of the header.

Embodiment 21: The packaging bag, packaging assembly, or method of any of the preceding embodiments, wherein a thickness of the first film composition is at least 2 mil and not greater than 15 mil.

Embodiment 22: The packaging bag, packaging assembly, or method of any of the preceding embodiments, wherein a thickness of the second film composition is at least 2 mil and not greater than 15 mil.

Note that not all of the activities described above in the general description or the examples are required, that a portion of a specific activity may not be required, and that one or more further activities may be performed in addition to those described. Still further, the order in which activities are listed is not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

The specification and illustrations of the embodiments described herein are intended to provide a general understanding of the structure of the various embodiments. The specification and illustrations are not intended to serve as an exhaustive and comprehensive description of all of the elements and features of apparatus and systems that use the structures or methods described herein. Separate embodiments may also be provided in combination in a single embodiment, and conversely, various features that are, for brevity, described in the context of a single embodiment, may also be provided separately or in any subcombination. Further, reference to values stated in ranges includes each and every value within that range. Many other embodiments may be apparent to skilled artisans only after reading this specification. Other embodiments may be used and derived from the disclosure, such that a structural substitution, logical substitution, or another change may be made without departing from the scope of the disclosure. Accordingly, the disclosure is to be regarded as illustrative rather than restrictive.

Note that not all of the activities described above in the general description or the examples are required, that a portion of a specific activity may not be required, and that one or more further activities may be performed in addition to those described. Still further, the order in which activities are listed are not necessarily the order in which they are performed.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims.

After reading the specification, skilled artisans will appreciate that certain features are, for clarity, described herein in the context of separate embodiments, may also be provided in combination in a single embodiment. Conversely, various features that are, for brevity, described in the context of a single embodiment, may also be provided separately or in any subcombination. Further, references to values stated in ranges include each and every value within that range.

What is claimed:

1. A packaging bag, comprising:
a transparent body having a first film composition; and
a tearable or peelable header comprising a second film composition, wherein the first film composition and the second film composition are different, wherein a component of the first film composition is bonded to the second film composition.

2. A packaging assembly comprising:
a product; and
a packaging bag enclosing the product to provide a sterilize-able packaging assembly, wherein the packing bag comprises:
a transparent body having a first film composition; and
a tearable or peelable header comprising a second film composition, wherein the first film composition and the second film composition are different, wherein a component of the first film composition is bonded to the second film composition, wherein the packaging bag is VHP resistant such that hydrogen peroxide concentration on an interior of the package is less than 1 ppm.

3. A method for forming a packaging bag, comprising:
providing a transparent body comprising a first film composition;
providing a tearable or peelable header comprising a second film composition;
bonding the second film composition to the first film composition to form a closed packaging bag; and
sterilizing the packaging bag such that the packaging bag is VHP resistant such that hydrogen peroxide concentration on an interior of the package is less than 1 ppm.

4. The packaging bag of claim 1, wherein the first film composition comprises polyethylene.

5. The packaging bag of claim 1, wherein the second film composition comprises polyethylene.

6. The packaging bag of claim 5, wherein the polyethylene of the first film composition is bonded to the polyethylene of the second film composition.

7. The packaging bag of claim 1, wherein first film composition comprises a laminated film comprising at least one of nylon or ethylene vinyl alcohol to form a multilayer film.

8. The packaging bag of claim 1, wherein second film composition comprises a laminated film comprising an alkyl methacrylate copolymer to form a multilayer film.

9. The packaging bag of claim 7, wherein the polyethylene film is an exterior layer or an interior layer of the first film composition.

10. The packaging bag of claim 8, wherein the polyethylene film is an exterior layer or an interior layer of the second film composition.

11. The packaging bag of claim 1, wherein the header is peelable against the body.

12. The method of claim 3, further comprising disposing a product within the packaging bag before bonding the second film composition to the first film composition.

13. The packaging assembly of claim 2, wherein the product is a medical or biopharmaceutical device.

14. The method of claim 3, wherein the sterilization step is done via radiation sterilization.

15. The method of claim 14, wherein the radiation sterilization is done via electron beam sterilization.

16. The packaging bag of claim 1, wherein the second film composition includes a foil.

17. The packaging bag, packaging assembly, or method of claim 16, wherein the foil comprises a metal.

18. The packaging bag of claim 1, wherein the packaging bag header is tearable or peelable upon application of force of no less than 1 lbf.

19. The packaging bag of claim 1, wherein the packaging bag comprises a front side and a back side, wherein one of the front side or the back side consists of the first film composition of the body.

20. The packaging bag of claim 1, wherein the packaging bag comprises a front side and a back side, wherein at least one of the front side or the back side comprises the first film composition of the body and the second film composition of the header.
